(19) United States
(12) Patent Application Publication
(10) Pub. No.: US 2006/0166099 A1
(43) Pub. Date: Jul. 27, 2006

(54) Closed nickel-hydrogen storage battery and its production method

(76) Inventors: Kazuya Okabe, Osaka (JP); Hiroaki Mori, Osaka (JP); Kengo Furukawa, Osaka (JP); Masaharu Watada, Osaka (JP); Toshiyuki Nukuda, Osaka (JP)

Correspondence Address: DELLETT & WALTERS, P. O. BOX 82788, PORTLAND, OR, 97282-0788, US

(21) Appl. No.: 10/542,896

(22) PCT Filed: Jan. 19, 2004
(86) PCT No.: PCT/JP04/00352

§ 371 Date: Jul. 20, 2005

(30) Foreign Application Priority Data
Jan. 20, 2003 (JP) 2003-011005
Jan. 16, 2004 (JP) 2004-009491

(51) Int. Cl. H01M 4/66; H01M 4/62; H01M 4/58; H01M 10/04; H01M 4/29

(52) U.S. Cl. 429/232; 429/245; 429/218.2; 29/623.1; 205/60

(57) ABSTRACT

One problem with a sealed type nickel-metal hydride battery is that the high-rate discharge capability is inferior to that of a nickel-cadmium storage battery, because of a slow transfer rate of charges to the surface of a hydrogen storing alloy that is a negative electrode. Another problem is that the use of an alloy having excellent life characteristics takes much time for initial activation of battery characteristics.

The invention provides a solution to the aforesaid problems by the provision of a sealed type nickel-metal hydride battery (1) improved in high-rate discharge capability and charge-discharge cycle characteristics. To this end, the invention is characterized by locating a 50 nm to 400 nm thick nickel-rich layer (11) on the surface of a hydrogen storing alloy powder, and locating the nickel-rich layer (11) as well on the surface of cracks (12) that open at the surface of alloy, and more preferably setting the mass saturation magnetization of the alloy powder at 2.5 to 9 emu/g and the content of magnetic nickel at 0.5 to 1.9 mmol per gram of the hydrogen storing alloy powder. A succession of hydrogen absorption step, alkali treatment step, product removal step, hydrogen desorption step and partial oxidization step by air are applied to the hydrogen storing alloy powder to obtain alloy powder, which is then used to obtain a battery having the aforesaid features. The invention is effectively applied to corrosion-resistant hydrogen storing alloys containing Er, Y and Yb.

### ART FIELD

The present invention relates generally to a nickel-metal hydride battery and its preparation process, and more specifically to improvements in the high-rate discharge capability of its negative electrode.

### BACKGROUND ART

In recent years, electric-powered equipments requiring high-current discharge, including electric cars and electric-powered tools, have increasingly grown. For power sources for such equipments, particular attention has now been directed to a sealed type nickel-metal hydride battery, because it provides a power source that is not only higher in the energy per unit volume and unit mass, but also environmentally cleaner, than nickel-cadmium or lead acid batteries. The nickel-metal hydride battery, because of allowing oxygen generated at a positive electrode upon overcharge to be absorbed in a negative electrode that contains hydrogen storing alloy powder, has another advantage of being more simplified in charge control mode, and in charge circuit as well, than lithium ion batteries.

However, one problem with nickel-metal hydride batteries is that their high-rate discharge capability is inferior to that of nickel-cadmium batteries because the hydrogen storing alloy has a slow charge transfer on its surface. Another problem is that when the hydrogen storing alloy composed mainly of rare earth elements, nickel and other transition metal elements that absorb and desorb hydrogen is used immediately as an electrode, initial activation takes much time to make full use of discharge capability; several tens or, in some cases, several hundreds charge-discharge cycles are needed for activation.

To provide solutions to these problems, especially the slow activation problem of the hydrogen storing alloy powder, many proposals have been made of how to treat their surface. Patent publication 1 (JP(A) 7-73878, paragraph 0011 at page 3) discloses a surface treatment method using an acidic aqueous solution having a pH value of 0.5 to 3.5. This method may make improvements in the activity of a hydrogen storing alloy by acid treatment, yet it is less effective. This is because the acid allows the rare earth element to dissolve out to form a surface layer containing more Ni than does the matrix component of the hydrogen storing alloy (hereinafter called the Ni-rich layer), but then Ni itself dissolves in the acidic aqueous solution and the ensuring Ni dissolves out, resulting in a failure in keeping the Ni-rich layer thick.

Patent publication 2 (JP(A) 2002-256301, paragraph 0009 at page 3) teaches a method in which a hydrogen storing alloy is immersed at 90° C. or higher in an aqueous solution containing 30 to 80% by weight of sodium hydroxide. With the use of such a method employing an alkaline aqueous solution, the activity of the hydrogen storing alloy may be improved; however, that method is less effective when applied to an alloy having a large particle size. This is because the alloy having a large particle size has a small specific surface area, and so a thickness larger than could be possible with an alloy having a small particle size is needed to ensure a Ni-rich layer accounting for a part of the alloy. With a Ni-rich layer of constant or larger thickness formed by the alkali treatment, however, the rate of formation of the Ni-rich layer slows down, leading to the inability to form a sufficient Ni-rich layer working as a reaction site. Moreover, the alkali forms a rare earth hydroxide or the like, which in turn covers the surface of the alloy powder, causing conductivity drops, and deterioration of high-rate discharge.

Patent publication 3 (JP(A) 9-7591, paragraphs 0017 to 0018 at page 3) and patent publication 4 (JP(A) 9-171821, paragraph 0007 at page 2) disclose a preparation process of hydrogen storing powder formed Ni-rich layer having a thickness of 50 to 200 nm wherein hydrogen storing powder is immersed in an alkali solution, and then immersed in a dilute acid solution, and a method in which hydrogen storing alloy powder is treated with an alkaline aqueous solution and then with an acidic aqueous solution, respectively. With the use of the process or method in which the alloy powder is treated with the alkali aqueous solution and then with the acid, the aforesaid rare earth hydroxide or the like formed upon the alkali treatment may be removed. However, it is less effective with alloy powder having a large particle size as is the case with the application of alkali treatment alone. Patent publication 5 comes up with the provision of a nickel coating layer on the surface of, and in cracks within, a hydrogen storing alloy as by electroless plating. The nickel coating layer set forth in patent publication 5 contains pure nickel or a small amount of P as sharply opposed to the nickel-rich layer of the invention that contains elements other than nickel that forms the hydrogen storing alloy, for instance, rare earth elements and transition metal elements such as cobalt, and so is quite different in composition than the aforesaid nickel-rich layer. In addition, the nickel coating layer set forth in patent publication 5 (JP(A) 2002-309327, paragraphs 0011 to 0013 at page 3) has an effect on prevention of the hydrogen storing alloy from dissolving in an alkaline electrolyte; that is, it does not make any contribution to the high-rate discharge capability of a nickel-metal hydride battery.

### DISCLOSURE OF THE INVENTION

### SUBJECT MATTER OF THE INVENTION

Having been accomplished to provide a solution to the aforesaid problems, the present invention has for the first object the provision of a sealed type nickel-metal hydride battery that is improved in terms of both high-rate charge-discharge capability and charge-discharge cycle performance. The second object of the invention is to provide a process that enables such a sealed type storage battery to be easily prepared at low costs. The third object of the invention is to provide hydrogen storing alloy powder having improved high-rate charge-discharge capability, which, even upon contact with air, are free of any risk of catching fire and kept back against inactivation.

### HOW TO ACHIEVE THE SUBJECT MATTER

To put the above subject matter to practice, we have made study after study. Consequently, we have now surprisingly found that a battery having improved high-rate discharge capability and excellent cycle life characteristics in combination is obtainable by locating a Ni-rich layer on a surface layer of, and in, a hydrogen storing alloy powder at a specific thickness and specifying the value of mass saturation magnetization, and arrived successfully at the invention. Here, the value of “mass saturation magnetization” is supposed to be determined by measuring a precisely weighed 0.3 gram of a hydrogen storing alloy powder sample filled in a sample holder with the application of a magnetic field of 5 kOe thereto, using a vibrating sample type magnetometer (Model BHV-30) made by Riken Denshi Co. Ltd.).

Referring to how to treat the hydrogen storing alloy powder according to the invention, hydrogen is absorbed in the alloy powder, as will be described later, to form therein cracks that open at the surface of the alloy powder. Then, the alloy powder is preferably immersed in a hot aqueous solution of NaOH. By that immersion, a Ni-rich layer of 50 to 400 nm in thickness is formed on the surface of the alloy powder, and a Ni-rich layer is formed as well on a surface (hereinafter referred to as the cracks surface) of the alloy powder newly formed by having that cracks. When charge-discharge cycles are carried out with a battery with a built-in hydrogen storing alloy that has not been subjected to the aforesaid treatment, too, there are cracks formed in the hydrogen storing alloy. With the untreated alloy, however, any Ni-rich layer having a large thickness as in the case with the treated one is not formed. Moreover, there is no striking effect on improvements in the high-rate discharge capability as contemplated herein.

When the hydrogen storing alloy powder is treated according to the invention, it is preferable that, as described later, the hydrogen storing alloy powder is treated using a specific treating solution, and then hydrogen is desorbed from them in a specific way. This ensures that the Ni-rich layer is formed in a ready way yet at low costs. More specifically, the treatment of the hydrogen storing alloy powder with a specific treating solution ensures that the Ni-rich layer is formed within a short time while the hydroxide of the rare earth formed at the treating step is readily removable. Further, it is possible to largely reduce the amount of costly hydrogen peroxide used for desorption of hydrogen. Furthermore, the hydrogen storing alloy is partially oxidized at a specific temperature in the final treating step. This ensures that the post-treatment hydrogen storing alloy powder is free of any risk of catching fire even upon contact with air, and kept back against inactivation as well.

To put the above subject matter to practice, the present invention is embodied as follows. However, it is noted that some action mechanisms have yet to be clarified and whether they make sense or not has no limitation on the invention.

(1) A sealed type nickel-metal hydride battery, comprising a positive electrode comprising an active material composed mainly of nickel hydroxide, a negative electrode comprising a hydrogen storing alloy powder composed mainly of rare earth elements, nickel and transition metal elements that absorb and desorb hydrogen, and an electrolyte composed mainly of an aqueous solution of an alkaline metal hydroxide, wherein:

a layer that contains more nickel than does a matrix component and has a thickness of 50 nm to 400 nm inclusive is located on a surface of said hydrogen storing alloy powder, and layers that contain more nickel than does a matrix component are located on a surface of cracks that open at the surface of said hydrogen storing alloy powder.

(2) The sealed type nickel-metal hydride battery according to (1) above, wherein said hydrogen storing alloy powder has a mass saturation magnetization of 2.5 to 9 emu/g.

(3) The sealed type nickel-metal hydride battery according to (1) or (2) above, wherein said hydrogen storing alloy powder contains magnetic nickel in an amount of 0.5 to 1.9 mmol per gram.

(4) The sealed type nickel-metal hydride battery according to any one of (1) to (3) above, wherein the cracks in said hydrogen storing alloy powder is formed by absorption of hydrogen into the alloy powder, and the hydrogen storing powder with cracks formed therein is treated with an alkaline aqueous solution, whereby the layer that contains more nickel than does the matrix component is formed.

(5) The sealed type nickel-metal hydride battery according to any one of (1) to (4) above, wherein said hydrogen storing alloy further contains one or two or more metals selected from the group consisting of erbium, yttrium, and ytterbium.

(6) A process of preparing the sealed type nickel-metal hydride battery according to any one of (1) to (5) above, comprising:

a first step of absorbing hydrogen in said hydrogen storing alloy powder composed mainly of rare earth elements, nickel and transition metal elements, thereby to form cracks therein,

a second step of treating the surface of the hydrogen storing powder and portions of the cracks that open at the surface of the alloy powder with an alkaline aqueous solution,

a third step of removing ions and hydroxides generated by treatment at the second step and composed mainly of the rare earth elements,

a fourth step of desorbing hydrogen out of the alloy powder, and

a fifth step of partially oxidizing the alloy powder by air.

(7) The sealed type nickel-metal hydride battery preparation process according to (6) above, wherein said cracks are formed by absorbing hydrogen in the said hydrogen storing alloy powder in an amount of 5% or more of an hydrogen absorption amount of the alloy powder.

(8) The sealed type nickel-metal hydride battery preparation process according to (6) or (7) above, wherein said alkaline aqueous solution is an aqueous solution of sodium hydroxide having a specific gravity of 1.3 to 1.5 at 20° C., and the treatment at the second step is carried out at a temperature of 100° C. to a boiling point of said aqueous solution for 30 minutes to 10 hours.

(9) The sealed type nickel-metal hydride battery preparation process according to any one of (6) to (8), wherein at the step of removing the ions and hydroxides generated by the treatment at the second step and composed mainly of the rare earth elements, the hydroxide is dissolved and ionized using an acid, whereby the ion composed mainly of the rare earth elements are separated from the hydrogen storing alloy powder by means of filtration.

(10) The sealed type nickel-metal hydride battery preparation process according to any one of (6) to (9) above, wherein at the step of desorbing hydrogen out of said alloy powder, hydrogen is desorbed out of the alloy powder by treating with warm water having a temperature of 80° C. or higher and a pH of 9 or less, and hydrogen peroxide solution is added as an oxidizing agent to the alloy powder at 45° C. or lower.

(11) The sealed type nickel-metal hydride battery preparation process according to any one of (6) to (10) above, wherein at the step of partially oxidizing said alloy powder by air, the alloy powder is partially oxidized by air having a temperature of 60 to 90° C.

(12) A process of preparing the sealed type nickel-metal hydride battery according to any one of (1) to (5), wherein the battery is prepared using a positive electrode in which the transition metal elements contained in said active material composed mainly of nickel hydroxide has an average oxidation number of 2.03 to 2.4.

(13) The sealed type nickel-metal hydride battery preparation process according to (12) above, wherein said active material composed mainly of nickel hydroxide is chemically oxidized with an oxidizing agent or electro-chemically oxidized by electrolysis.

### ADVANTAGES OF THE INVENTION

According to the invention recited in claims 1 to 5, a sealed type nickel-metal hydride battery that has improved high-rate discharge capability and excellent cycle performance as well can be provided, thereby overcoming the demerits of this type of conventional nickel-metal hydride batteries. Thus, the invention would meet the demands for applications needing high-current performance such as electric cars and electric-powered tools, contributing to society.

According to the invention recited in claims 6 and 7, provision can be made of a sealed type nickel-metal hydride battery that is activated within a short time yet with an increased service life and improved high-rate discharge capability as well, even when an alloy of improved corrosion resistance is used with a view to seeking particularly improved cycle performance. Thus, the invention would help improve the performance of equipment with which that storage battery is used, increasing the range of its use.

According to the invention recited in claims 8 and 9, there can be provided a process for efficient preparation of a sealed type nickel-metal hydride battery that, as described above, possesses improved high-rate discharge capability and satisfactory cycle performance as well.

According to the invention recited in claims 10 and 11, the first step can be carried out in a readily and precisely controllable way to achieve the advantages of claims 8 and 9.

According to the invention recited in claims 12 and 13, the second step can be carried out at low costs and within a short time to achieve the advantages of claims 8 and 9.

According to the invention recited in claims 14 and 15, the third step capable of obtaining a battery excellent in high-rate discharge capability in particular can be provided together with the advantages of claims 8 and 9.

According to the inventions recited in claims 16 and 17 as well as claims 18 and 19, provision can be made of a process for the preparation of a sealed type nickel-metal hydride battery that efficiently possesses the aforesaid performance without ever using system-polluting chemicals at the fourth and fifth steps.

According to the invention recited in claims 20 to 23, the sealed type nickel-metal hydride battery recited in claims 1 to 7 can be improved in terms of discharge capacity and cycle performance.

### BRIEF EXPLANATION OF THE DRAWINGS

FIG. 1 is illustrative in section of part of the sealed type nickel-metal hydride battery that is one embodiment of the invention.

FIG. 2 is a photograph that shows an enlarged section of a hydrogen storing alloy applied to the sealed type nickel-metal hydride battery according to the invention.

### EXPLANATION OF THE REFERENCE NUMERALS

Reference numeral 1 stands for a sealed type nickel-metal hydride battery, 2 a positive electrode, 4 a negative electrode, 5 a separator, 11 a nickel-rich layer, and 12 cracks.

### BEST MODE FOR CARRYING OUT THE INVENTION

Through analyses of high-rate discharge resistance components in sealed type nickel-metal hydride batteries, we have ascertained that the negative electrode accounts for a substantial portion of resistance upon high-rate discharge. Then, we have made studies of surface treatments for hydrogen storing alloys to improve a charge transfer rate at the alloy surface of a negative electrode upon high-rate discharge, finding out that unexpectedly high-rate discharge performance is achievable by use of an alloy having specific structure. That is, we have discovered that much more improved high-rate discharge capability is achievable when hydrogen is absorbed in a hydrogen storing alloy in an amount of at least 5% of its hydrogen absorption amount to form fine cracks in the alloy powder, and the said Ni-rich layers are then formed on the alloy surface and the surfaces of cracks that open at with that alloy powder surface, using an alkaline aqueous solution.

Especially when the Ni-rich layer formed on the surface of hydrogen storing alloy powder has a thickness of 50 nm to 400 nm inclusive, preferably 170 nm to 400 nm inclusive, and the hydrogen storing alloy powder has a mass saturation magnetization in the range of 2.5 to 9 emu/g, preferably 4 to 9 emu/g and a magnetic nickel content of 0.5 to 1.9 mmol/g, the high-rate discharge capability of the battery is found to be much more improved. When the Ni-rich layer located on the surface of the hydrogen storing alloy powder had a thickness of less than 50 nm, there was no improvement in the high-rate discharge capability, and at greater than 400 nm there was a cycle life performance drop, although some improvements were observed in high-rate discharge.

Likewise, when the mass saturation magnetization was less than 2.5 emu/g and the magnetic nickel content was less than 0.5 mmol/g, there was a high-rate discharge capability drop, and when the mass saturation magnetization exceeded 9 emu/g and the magnetic nickel content exceeded 1.9 mmol/g, there was the alloy capacity drop. The high-rate discharge capability is not merely determined by the area or amount of the Ni-rich layer that is a discharge reaction site; it is heavily affected by a site where the Ni-rich layer is found, and the Ni-rich layer formed on the surface of the cracks formed in the powder has a striking effect on it. Preferably but not exclusively, the Ni-rich layer formed on the cracks surface has a thickness that is equal to, or at most twice as large as, that of the Ni-rich layer located on the powder surface.

Although the action and effect of the Ni-rich layer located on the cracks surface have yet to be clarified, a possible reason for them could be that with an alloy powder having no crack therein and no nickel-rich layer on the surface thereof, hydrogen must migrate a long distance in the alloy for a hydrogen desorption reaction at the alloy surface upon discharge, whereas with an alloy having a nickel-rich layer therein, hydrogen moves to the nickel-rich layer in the alloy, and then moves to an alloy surface portion at a much faster speed through the nickel-rich layer in the alloy than through the alloy.

Usually, a hydrogen storing alloy with erbium, yttrium and ytterbium added thereto as corrosion preventives is less likely to have activity improved by ordinary surface treatment, because its activation is particularly slow. With the aforesaid treatment, however, it has been found that activation proceeds at a speed twice to triple as fast as usual. A possible reason for this could be that the alloy whose surface activation is less susceptible to proceed has a large activation site by the formation of cracks, and the provision of the nickel-rich layer on the surfaces of the cracks makes the migration of hydrogen from within the alloy to its surface portion faster as compared to cracks-free alloy, resulting in some considerable improvements in electrode performance.

The hydrogen storing alloy composed as described above is prepared by pressurizing a hydrogen storing alloy in hydrogen gas to allow hydrogen in at least 5% of the hydrogen absorption amount of the alloy to be contained therein in a gas phase for cracking. Alternatively, the alloy could be corroded by an alkaline aqueous solution to generate hydrogen in an amount of at least 5% as mentioned above, which is in turn absorbed in the corroded alloy under atmospheric pressure. Absorption of hydrogen in an amount of 30% or more is preferable because high-rate discharge capability is much more improved probably by the formation of more cracks.

Surface treatment of the alloy with the alkaline aqueous solution causes rare earths such as lanthanum to dissolve out of the alloy surface, forming rare earth ions and their hydroxides. If, at this time, at least 5% of hydrogen is contained in the hydrogen storing alloy, it is then possible to largely reduce the dissolution of Ni and Co because they are not at the dissolution potential. For this reason, the Ni-rich layer is formed with high-rate, and sufficient activity is obtained with the minimum immersion treatment at the minimum Ni-rich layer thickness, minimizing capacity reductions due to the flowing of the rare earths out of the alloy. If, in this case, the powder is fabricated into a storage battery electrode with oxide and hydroxide products remaining around them, there is then an increased electric resistance of the powder, leading to a high-rate discharge capability drop. Thus, it is desired to remove such rare earth compounds.

The alkaline aqueous solution for the treatment, aqueous solutions of alkaline metal hydroxides such as KOH, NaOH and LiOH are preferably employed alone or in admixture of two or more, because their composition ratio is so similar to that of an electrolyte of the battery. Then, the alloy powder is fabricated into a battery, there is no dissolution of new elements, which substantially keeps the alloy against corrosion. NaOH has an advantage of making the treating time shorter, because its corrosion rate for the alloy surface is at least twice faster than that of LiOH or KOH.

Higher NaOH concentrations are preferable, because the corrosion speed is then so faster that there can be a reduced treating time at a specific gravity of 1.3 or more as measured at 20° C. At a specific gravity exceeding 1.5, however, crystals precipitate at normal temperature, rendering the alloy hard to handle, and so a specific gravity of 1.5 or less is preferable.

The treating temperature is preferably 100° C. or higher, at which the treating speed is drastically improved. At a temperature higher than the boiling point of the treating solution, however, the reaction rate is too high for control, and there is a facility problem as well. Thus, the treating temperature should preferably be lower than that boiling point.

The treating time is preferably 30 minutes or longer, because too short a time renders the formation of the Ni-rich layer less than satisfactory. However, a treating time of 10 hours or longer means that the process lingers, and may cause too much Ni-rich layer to be formed although depending on the concentration of the treating solution, leading to a battery capacity reduction. Thus, the treating time should preferably be 10 hours or less.

Removal of rare earth impurities is achievable by a method making use of a precipitating rate difference of the said impurities and the alloy powder in the aqueous solution wherein, for instance, running water is flowed from a lower portion of an agitation tank with alloy particles placed therein to remove hard-to-precipitate rare earth compounds with the running water, and a method making use of a particle size difference wherein, for instance, rare earth compounds smaller in particle size than the alloy particles are filtered out. However, both methods involve complicated steps and so are of poor efficiency. It is therefore preferable to rely upon a method for filtering out rare earth compounds while they are dissolved in a dilute acid such as hydrochloric acid or acetic acid, and particular preference is given to hydrochloric acid by virtue of its inexpensiveness and handleability.

The post-treatment alloy, because of containing hydrogen, has a risk of generating heat and catching fire in the atmosphere upon its forming into an electrode. For this reason, it is preferable to desorb hydrogen out of the alloy. Desorption of hydrogen out of the alloy may be achieved by oxidization of the alloy using oxidizing agents such as an aqueous solution of H₂O₂. However, the use of such chemicals in large amounts is not favorable because of their high price. It is thus preferable to pre-treat the alloy by exposing it to warm water of 80° C. or higher and a pH of 9 or less in particular, because much of hydrogen contained in the alloy can be desorbed out of it in an efficient, inexpensive and safe way. Although any desired oxidizing agent may be used for the post-treatment, yet it is preferable to use hydrogen peroxide because its decomposition product does not contain impurities that render alloy performance worse. These oxidizing agents decrease in efficiency at 45° C. or higher because upon contact with the Ni-rich layer on the alloy, they give out oxygen gas, coming off self-decomposition. For the oxidizing agents, it is preferable to cool them down to lower than 45° C. because of their efficient reaction with hydrogen in the alloy.

The alloy decreases in activity upon oxidization by air. As the alloy is stored in a hydrous state, it becomes alkaline as a result of dissolution of rare earths in the alloy. Subsequently, its corrosion goes to such a point that when the alloy is formed into an electrode, there is an extremely capacity drop. A problem with alloy powder that is not oxidized at the surface as by vacuum drying is that due to too high an activity, it is likely to catch fire in the atmosphere, causing a catch-fire accident during transportation or alloy feeding at the processing step. It is thus preferable to partially oxidize the alloy with an air of 60° C. to 90° C., because although the surface of the alloy is oxidized, the drop of high-rate discharge capability is limited. A possible reason for this could be that the oxide film formed on the alloy surface is so thin that it can be re-reduced or peel off in the activation operation of a battery after assembled.

If such operations as described above are carried out, it is then possible to obtain powder of a negative electrode-dedicated hydrogen storing alloy that does not suffer from capacity drops during long-term storage, has no risk of catching fire during storage, handling or the like, and possesses safe, excellent high-rate discharge capability.

Some embodiments of the invention are now explained at great length.

However, it is noted that the invention is by no means limited to the following embodiments.

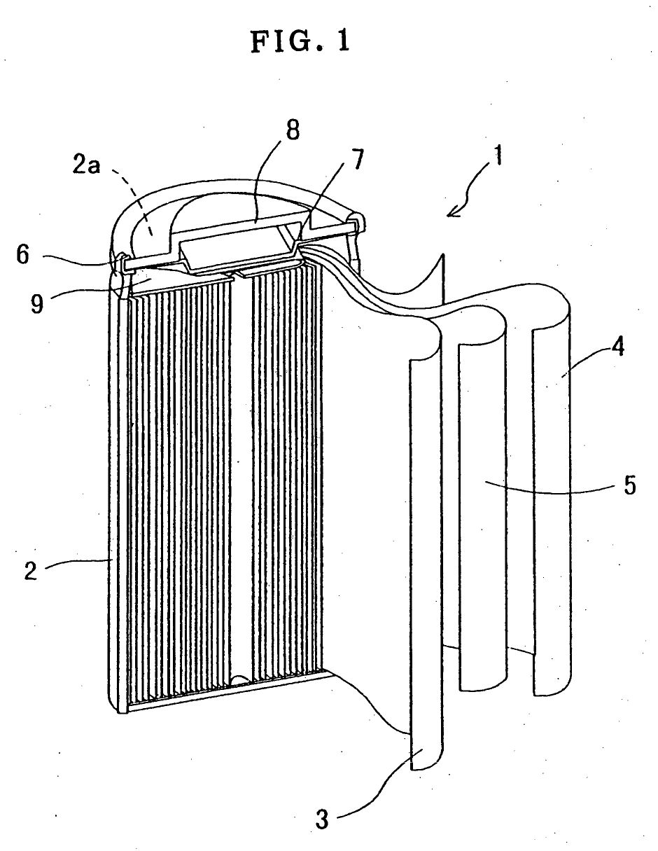

The sealed type nickel-metal hydride battery according to the invention is built up of a positive electrode comprising nickel hydroxide as a major constituent, a negative electrode comprising a hydrogen storing alloy powder as a major constituent, and an alkaline electrolysis solution containing an alkaline metal hydroxide in a water solvent, generally with a separator interposed between the positive electrode and the negative electrode. FIG. 1 is illustrative in section of a typical inventive storage battery in which the positive and negative electrodes are wound up with the separator interposed between them. In FIG. 1, reference numeral 1 represents a sealed type nickel-metal hydride battery, 2 an outer casing of the battery, 2a an upper opening, 3 a positive electrode, 4 a negative electrode, 5 a separator, 6 an insulating gasket, 7 a sealing sheet, 8 a positive terminal, and 9 a collector.

While nickel hydroxide with zinc hydroxide and cobalt hydroxide added to it may be used for a positive electrode active material, it is preferable to use a nickel hydroxide-based composite hydroxide obtained by uniform dispersion of these compounds by coprecipitation. To give electric conductivity to the positive electrode, powder of cobalt hydroxide or cobalt oxide may be mixed with, and added to, that nickel hydroxide-based composite hydroxide, or that nickel hydroxide-based composite hydroxide may be coated with cobalt hydroxide. In this case to oxidize the cobalt which is contained the said cobalt hydroxide or cobalt oxide with oxygen or oxygen-containing gas is effective for preventing formation of discharge reserve. Also to oxidize not only the said cobalt but also a part of nickel which is contained the said nickel hydroxide-based composite hydroxide using an oxidizing agent such as K₂S₂O₈ or hypochlorous acid is effective too. Alternatively, the nickel hydroxide-based composite hydroxide coated with a layer of cobalt hydroxide may be filled in a porous substrate into an electrode, in which the cobalt and a part of the nickel are then electrochemically oxidized in an alkaline electrolyte. If the prevention of formation of discharge reserve by chemical or electrochemical oxidization of the nickel hydroxide-based composite hydroxide coated with the layer of cobalt hydroxide (hereinafter called the positive electrode active material particles) is used in combination with the negative electrode comprising the hydrogen storing alloy with the Ni-rich layers formed on the surface of the aforesaid powder and the surface of cracks, it is then possible to make further improvements in battery capacity and cycle performance. The transition metal element contained in the positive electrode active material particles (nickel and cobalt in the case of particles containing nickel hydroxide, zinc hydroxide and cobalt hydroxide) should preferably have an average oxidation number of 2.04 to 2.4. When nickel and cobalt have an average oxidation number of less than 2.04, there is no effect whatsoever on the prevention of formation of discharge reserve.

Exceeding the average oxidation number of 2.4 is not preferable because the effect on the prevention of formation of discharge reserve that is observed in the average oxidation number range of 2.04 to 2.4 is not obtained at all, rendering discharge capacity worse.

To boost up the oxygen overvoltage at the positive electrode thereby improving discharge efficiency, it is further effective to add oxides or hydroxides of rare earths such as Y and Yb to the positive electrode.

No special limitation is imposed on the composition of the hydrogen storing alloy that is the major constituent of the negative electrode active material, insofar as it is an alloy that is capable of absorbing hydrogen and generally called an AB₂ or AB₅ type alloy. Particular preference is given to an AB₅ type alloy MmNi₅ (Mm is a mixture of rare earth elements), in which a part of Ni is substituted by Co, Mn, Al, Cu or the like, because of having excellent charge-discharge cycle life characteristics and high discharge capacity. Yttrium, ytterbium and erbium as well as oxides or hydroxides of gadolinium and cerium may be added to the hydrogen storing alloy as corrosion preventives, or these elements in the form of metals may be previously contained in the hydrogen storing alloy.

The powder of the positive electrode active material, and the powder of the negative electrode active material should preferably have a mean particle size of 50 μm or less. Especially for the powder of the hydrogen storing alloy that is the negative electrode active material, it is preferable to have a mean particle size of as small as 40 μm or less so as to improve the output of the sealed type nickel-metal hydride battery; however, it is desirable to have a mean particle size of 20 μm or more so as to obtain an increased cycle life. When the Ni-rich layer of 50 nm to 400 nm inclusive in thickness is located on the surface of the alloy according to the invention and the Ni-rich layer is located along the cracks open at that surface as well, the hydrogen storing alloy should more preferably have a mean particle size of 30 μm to 50 μm, because improved high-rate discharge capability is obtainable even at large particle sizes.

To obtain powder of given shape, a variety of grinding machines and classifiers could be used. For instance, use could be made of mortars, ball mills, sand mills, vibration ball mills, planetary ball mills, jet mills, counter jet mills, and cyclonic jet mills. For grinding, wet grinding could be carried out using water or an aqueous solution of alkaline metal hydroxides. Sieves, pneumatic classifiers, etc. could not exclusively be used for classification that could be carried out wet or dry, if required.

While detailed accounts have been given of the positive and negative electrode active materials that are the major constituents of the positive and negative electrodes, it is understood that other subordinate constituents such as electrical conducting agents, binders, viscosity increasers and fillers could be contained in the positive and negative electrodes.

Any desired electrical conducting material could be used for the electrical conducting agent, insofar as it has no adverse influence on battery performance. For instance, use could usually be made of natural graphite such as scaly graphite and earth graphite, artificial graphite, carbon black, acetylene black, ketchen black, carbon whiskers, carbon fibers, gas phase-grown carbon, metal (e.g., copper, nickel, gold) powders and metal fibers that could be used alone or in admixture.

Of those conducting agents, acetylene black is desired in consideration of electron conductivity and coat capability. The conducting agent is preferably used in an amount of 0.1% by weight to 10% by weight relative to the total weight of the positive or negative electrode. More preferably, acetylene black should be pulverized to ultra-fine particles of 0.1 to 0.5 μm for use, because of the ability to reduce the necessary amount of carbon. Mixing of the conducting agent is carried out by physical mixing means, ideally homogeneous mixing means. To this end, powder mixers such as V-type mixers, S-type mixers, automated mortars and planetary ball mills could be used dry or wet.

Usually for the binder, use could be made of thermoplastic resins such as polytetrafluoroethylene (PTFE), polyethylene and polypropylene, and polymers having rubbery elasticity such as ethylene-propylene-diene terpolymer (EPDM), sulfonated EPDM, styrene-butadiene rubber (SBR) and fluororubber which could be used alone or in admixture of two or more. The binder is preferably used in an amount of 0.1 to 3% by weight relative to the total weight of the positive or negative electrode.

Usually for the viscosity increaser, use could be made of polysaccharides such as carboxymethylcellulose and methyl cellulose which could be used alone or in admixture of two or more. The viscosity increaser is preferably used in an amount of 0.1 to 3% by weight relative to the total weight of the positive or negative electrode.

For the filler, any desired filler material could be used insofar as it has no adverse influence on battery performance. Usually, olefinic polymers such as polypropylene and polyethylene, carbon, etc. could be used. The filler is preferably used in an amount of 5% by weight or less relative to the total weight of the positive or negative electrode.

Preferably, the positive electrode, and the negative electrode is prepared by mixing together the active material, conducting agent and binder in water or an organic solvent such as alcohol or toluene, and then coating the obtained mixture on a collector that will be detailed later, finally followed by drying. For instance, the mixture is preferably coated on the collector into any desired shape having any desired thickness, preferably but not exclusively, by means of roller coating such as applicator roller coating, screen coating, doctor blade coating, spin coating, and bar coater coating.

No particular limitation is imposed on the collector for the positive electrode, insofar as it is made up of an electron conductor having no adverse influence of the assembled battery. For instance, nickel sheets or nickel-plated steel sheets are preferably used. Besides, foamed materials, formed fiber bundles and three-dimensional pit-and-projection materials as well as two-dimensional materials such as punched steel sheets are usable. By way of example but not by way of limitation, the collector has a thickness of 5 to 700 μm. of those collectors, it is preferable to use a collector for the positive electrode, in which Ni improved in terms of corrosion resistance to alkalis and resistance to oxidization is formed into a foamed porous structure having good collector capability.

For the collector for the negative electrode, it is preferable to use a porous sheet obtained by punching out an iron or steel foil or sheet of good conductivity and Ni-plating the foil or sheet so as to improve resistance to reduction. It is then preferable that the pores created by the punching of the steel sheet have a diameter of 1.7 mm or less and the collector has an aperture ratio of 40% or greater, thereby improving the adhesion of the negative electrode active material to the collector even when a smaller amount of binder is used. Not only fired carbon fibers and conductive polymers but also Ni powder, carbon, platinum or the like could be deposited onto the surface of the nickel in the collector for the purpose of improving adhesion, conductivity and resistance to oxidization. These materials could be oxidized on their surfaces.

For the separator for the sealed type nickel-hydrogen batteries, known porous films or unwoven fabrics having excellent high-rate discharge capability could be used alone or in combination. The separator, for instance, could be formed of a polyolefinic resin represented by polyethylene or polypropylene, and nylon. In consideration of strength and gas permeability, the separator has a porosity of preferably 80% by volume or less, and in view of charge-discharge capability, the porosity is preferably 20% by volume or greater. The separator is also preferably subjected to hydrophilic treatment. For instance, the surface of the polyolefinic resin fibers such as polyethylene fibers could be subjected to graft polymerization treatment with hydrophilic groups, sulfonation treatment, corona treatment or PVA treatment or, alternatively, sheets mixed with the fibers already subjected to those treatments could be used.

For the electrolyte, those generally proposed for application to alkaline batteries or the like are usable. By way of illustration but not by way of limitation, electrolytes obtained by dissolving a solute or solute mixture comprising hydroxides of potassium, sodium and lithium in a solvent water. As corrosion preventives for the alloy or additives for the purpose of improving overvoltage at the positive electrode, corrosion resistance of the negative electrode and self-discharge, compounds of yttrium, ytterbium, erbium, calcium, sulfur, zinc and or the like could be added to the electrolyte solution, alone or in admixture of two or more.

Referring to the concentration of the electrolyte salt in the electrolyte, an aqueous solution containing 5 to 7 mol/l of potassium hydroxide and 0.5 to 0.8 mol/l of lithium hydroxide is preferable so as to ensure a battery having high battery performance.

Preferably, the sealed type nickel-metal hydride battery according to the invention is prepared by poring the electrolyte in a stack of the separator, positive electrode and negative electrode for such a storage battery before or after they are stacked together, and finally sealing up the stack with an outer casing material. Referring here to a sealed type nickel-metal hydride battery in which element comprising a positive electrode stacked on a negative electrode with a sealed type nickel-metal hydride battery separator interposed between them is rolled up, it is preferable to pour the electrolyte in the electric generation element before and after it is wound up. The electrolyte may be poured in the element at normal pressure; however, vacuum impregnation, pressurized impregnation or centrifugal impregnation, too, could be used.

The outer casing for the sealed type nickel-metal hydride battery could be formed of materials such as nickel-plated iron or stainless steel and polyolefinic resins, or a composite material comprising them.

No particular limitation is placed on the makeup and configuration of the sealed type nickel-metal hydride battery; for instance, it could be configured in the form of a coin, button, prismatic or flat battery, all comprising a positive electrode, a negative electrode and a single- or double-layer separator, or a cylindrical or other battery comprising a positive electrode, a negative electrode and a separator, all in a roll form.

### EXAMPLES

While the invention is now explained at great length with reference to examples, it is understood that the invention is not limited to what will be described below; testing methods, the positive electrode active material, negative electrode material, positive electrode, negative electrode, electrolyte and separator that form together a battery, battery configuration, etc. could be determined by choice.

### Examples 1, 2, 3, 4, 5

### Synthesis of Nickel Hydroxide Particles

Ammonium sulfate and a caustic soda aqueous solution were added to an aqueous solution with nickel sulfate, zinc sulfate and cobalt sulfate dissolved therein in such a way that the hydroxide of each metal was at the mass ratio to be described later, thereby forming an ammine complex. While the reaction system was vigorously stirred, another caustic soda was added dropwise to it, and the reaction bath was controlled at a temperature of 45±2° C. and a pH of 12±0.2 to synthesize spherical high-density nickel hydroxide particles providing a core-layer matrix material, with the respective hydroxides being at a mass ratio of 93:5:2 for nickel, zinc and cobalt.

### Provision of the Surface Layer on the Surface of the Nickel Hydroxide Particle

The aforesaid high-density nickel hydroxide particles were charged in an alkaline aqueous solution controlled by caustic soda to a pH of 12±0.2. While that solution was agitated, an aqueous solution containing cobalt sulfate and ammonia at given concentrations was added dropwise to it. In the meantime, an aqueous solution of NaOH was optionally added dropwise to the reaction bath to hold it at a temperature of 45±2° C. and a pH of 12±0.2, thereby forming on the surface of the nickel hydroxide particle a surface layer composed of a Co-containing hydroxide mixture. The proportion of the surface layer in that hydroxide mixture was 7% by weight relative to the core-layer matrix material particles (hereinafter called the core layer).

### Oxidization Treatment of the Positive Electrode Active Material Particles

One hundred (100) grams of the nickel hydroxide particles having the surface layers composed of the aforesaid hydroxide mixture were charged and fully agitated in an aqueous solution of NaOH having a concentration of 10% by weight at a temperature 60° C. Subsequently, 45 ml of a sodium hypochlorite solution (made by Wako Junyaku Kogyo Co. Ltd.) were added to the solution for a further 30-minute stirring. Active material particles were filtered out, washed with water, and dried. Twenty (20) grams of an aqueous solution of NaOH having a concentration of 30% by weight at a temperature of 80° C. with the obtained active material particles placed therein were held at a temperature of 80° C. for 2 hours, whereupon the product was washed with water, and dried. The average oxidation number of the transition metal elements (Ni, Co) contained in the obtained active material particles were measured in a known way (wherein the active material particles react with ammonium ferrous sulfate, followed by oxidation-reduction titration with potassium permanganate). As a result, the transition metal elements (Ni, Co) were found to have an average oxidation number of 2.15.

### Preparation of the Positive Electrode Plate

An aqueous solution of carboxymethylcellulose (CMC) was added to the aforesaid active material particles to make a paste consisting of the active material particles and CMC solute at a ratio of 99.5:0.5, which was then filled in a nickel foamed material of 450 g/m² (sold from Sumitomo Electric Industries, Ltd. under the trade name of Nickel Cermet #8). Then, the foamed material was dried at 80° C. and pressed to a given thickness to coat the surface of that material with polytetrafluoroethylene, thereby making a nickel positive electrode plate having a width of 34 mm that includes a 1-mm coating-free portion, a length of 260 mm, and a capacity of 3,000 mAh.

### Preparation of the Negative Electrode Plate

First Step

A hydrogen storing alloy powder having a particle size of 35 μm and an AB₅ type rare earth MmNi_{3.6}Co_{0.6}Al_{0.3}Mn_{0.35} (Mm: Mischmetal composed mixture of rare earth elements) composition were placed in a sealed vessel with a hydrogen atmosphere prevailing in it, in which it was let alone at 45° C. for 2 hours to absorb hydrogen in that alloy. In this case, the internal hydrogen pressure of the sealed vessel was set at the pressures equal to the hydrogen equilibrium pressures of the hydrogen storing alloy that absorbed hydrogen in amounts of 5%, 10%, 20%, 30%, and 50%. After pressurization, the alloy powder is removed to obtain 5 hydrogen storing alloy powder that absorbed hydrogen in the amounts of 5 to 50%. The term “hydrogen absorption amount” referred herein is defined as the amount of hydrogen absorbed, H/M (the number of hydrogen atoms per metal atom), in a reference atmosphere at a temperature of 60° C. and an equilibrium hydrogen pressure of 1 MPa. For instance, that an alloy has a hydrogen absorption amount of 50% means that the alloy absorbs hydrogen in an amount of 50% of the absorption amount in the aforesaid reference

Second Step

An alkaline aqueous solution was applied to the alloy to treat the alloy surface and fine cracks in the alloy. More specifically, after the hydrogen storing treatment, the alloy powder is immersed in an aqueous solution of NaOH having a specific gravity of 1.1 to 1.5 at 20° C. for 30 minutes to 10 hours at 80° C. to the boiling temperature. Detailed conditions for the treatment such as NaOH concentration, temperature and time will be given later.

Third Step

After that, the content was filtered out under pressure, and then washed with water until a pH of 10 or less was obtained. Thereafter, dilute hydrochloric acid was added to the product to dissolve rare earth hydroxides, etc. therein, followed by filtration under pressure.

Fourth Step

After that, hydrogen desorption was carried out using 80° C. warm water. The warm water was removed from the product by filtration under pressure, and the product was washed with water. Then, a 4% hydrogen peroxide solution was added to the product in an amount equal to the weight of the alloy while stirring was carried out in water for oxidization. Finally, filtration and drying gave a hydrogen storing alloy for the electrode.

### Investigation of the Magnetic Nickel Content

A magnetic field of 5 kOe was applied to a precisely weighed 3 g of the post-treatment hydrogen storing alloy powder sample to measure its mass saturation magnetization using a vibration sample type magnetometer (Model BHV-30 made by Riken Denshi Co., Ltd.). On the other hand, a section of the alloy powder was observed under a transmission electron microscope to measure the thickness of the nickel-rich layers on the powder surface and the cracks in the powder. At the same time, the composition ratio of nickel and cobalt in intermediate portions of the nickel-rich layers in the thickness direction was measured to determine, from the mass saturation magnetization of cobalt and nickel, what relations were between the mass and the mass saturation magnetization of cobalt and nickel in a state where cobalt and nickel were mixed together at the same ratio as the aforesaid composition ratio, thereby making a calibration curve. By checking the mass saturation magnetization of the aforesaid sample against that calibration curve, the amount of magnetic nickel was determined.

### Electrode Preparation

The thus obtained alloy powder and a styrene-butadiene copolymer emulsion were mixed together at a dry-basis weight ratio of 99.35:0.65, and the mixture was dispersed in water into a paste, which was in turn coated by a blade coater on a punched steel sheet obtained by nickel plating of iron, dried at 80° C., and pressed into a given thickness to obtain a hydrogen storing alloy negative electrode plate having a width of 34 mm that included a 1-mm coating-free portion, a length of 260 mm, and a capacity of 4,800 mAh.

### Testing Battery Preparation

FIG. 1 is illustrative in section of part of a testing battery 1. A hydrogen storing alloy negative electrode sheet 4, a 120-μm thick unwoven fabric separator 5 composed of sulfonated polypropylene fibers and a nickel electrode plate 3 were assembled together and rolled up into an element. A positive electrode collector terminal 9 was joined to the end face of a positive electrode substrate extending from the upper end face of the rolled-up element, and a negative electrode collector terminal (not shown) was joined to the lower end face of the rolled-up element and then inserted into a metallic battery casing 2 to join the negative electrode collector terminal to the inside bottom surface of the battery casing 2. An alkaline electrolysis solution, in which 0.8 mol/l of lithium hydroxide was dissolved in 6.8 mol/l of an aqueous solution of potassium hydroxide, was poured in the battery casing. Then, a metallic lid 8 having a sealing sheet 7 and a vent plug (not shown) having an opening pressure of 2.4 MPa was positioned on an upper opening 2a in the battery casing 2 via a gasket 6, and crimp sealed to prepare a subC sealed type nickel-metal hydride battery 1. It is here noted that electrical connection was made to the lid 8 that was a combined positive electrode collector terminal 9 and positive electrode terminal via the sealing sheet 7.

### Preparation, and Formation of the Testing Battery

After a 12-hour storage at 40° C., this battery was charged to 600 mAh at 0.02 ItA, and then at 0.1 ItA for a further 12 hours. Furthermore, the battery was discharged to 1 V at 0.2 ItA, followed by a 12-hour charge at 0.1 ItA and a discharge to 1 V at 0.2 ItA. This operation was repeated four times.

The alloys that, at the first step, absorbed hydrogen at 0%, 5%, 10%, 20%, 30%, 50% of the hydrogen absorption amount of the starting alloy, were treated with an aqueous solution of NaOH having a specific gravity of 1.5 at 20° C. for varying times in such a way as to obtain a mass saturation magnetization of 5 emu/g at 110° C. The thickness of the Ni-rich layers of the obtained powder was measured. Each alloy was used to prepare a battery according to the aforesaid process, and the discharge capacity of the battery was measured after it was charged at 0.1 ItA for 12 hours, then let alone at 5° C. for 5 hours for adequate cooling and finally discharged to 0.8 V at 10 ItA. Here the discharge capacity was given in terms of the ratio to the discharge capacity at the fourth of four discharge operations, each comprising a 12-hour charge at 0.1 ItA and a discharge to 1 V at 0.2 ItA at the aforesaid formation process. Of the obtained alloy powder, the alloy powder that absorbed hydrogen in the amounts of 5%, 10%, 20%, 30% and 50% are called inventive alloys 1, 2, 3, 4 and 5, respectively, and the corresponding batteries prepared as described above inventive batteries 1, 2, 3, 4 and 5, respectively. A hydrogen storing alloy obtained as in inventive alloy 1 with the exception that the amount of hydrogen absorbed was 0% is called comparative alloy 1, and the corresponding battery comparative example 1.

Set out in Table 1 are the thickness of the Ni-rich layers formed on the surfaces of the hydrogen storing alloy powder and the results of discharge testing of the nickel-metal hydride batteries. The thicknesses of the Ni-rich layers shown in Table 1 were the measurements of the Ni-rich layers formed on the surfaces of the hydrogen storing alloy powder, and given by two significant figures in the median value of measurements at ten sites each. It is here noted that although the thicknesses of the Ni-rich layers along the cracks in the inventive alloy powder is not mentioned, they were found to be at most twice as large as those on the surfaces of the powder. In comparative example 1, there was no crack in the alloy powder, and no Ni-rich layer on the surface of the alloy either.

TABLE 1

| | amount of | | | discharge |
|---|---|---|---|---|
| | hydrogen | treating | Ni-rich layer | capacity at |
| example | absorbed (%) | time (h) | thickness (nm) | 10 ItA (%) |
| comparative | 0 | 2 | 250 | 4 |
| example1 | | | | |
| example1 | 5 | 1.7 | 230 | 80 |
| example2 | 10 | 1.6 | 220 | 82 |
| example3 | 20 | 1.6 | 220 | 83 |
| example4 | 30 | 1.4 | 200 | 88 |
| example5 | 50 | 1.3 | 180 | 88 |

In inventive alloys 1 to 5, the quantity of mass saturation magnetization is set at the same 5 emu/g by changing the reaction time, because it would be reasonable to keep the magnetic material working as a reactive site in the same amount for comparison of the effects of the Ni-rich layers in the alloy. When the amount of hydrogen absorbed in each of inventive alloys 1 to 5 was 5% or greater as calculated on the gas phase basis of the alloy, it could be found that even with the same magnetic material content, the high-rate discharge capacity of each inventive battery at 5° C. is much higher than that of comparative battery 1 having no Ni-rich layer in the alloy. As an alloy had hydrogen absorbed in an amount of 30% on the basis of its hydrogen absorption amount, its discharge capacity is far much more improved; the discharge capacity at 5° C. and 10 ItA reaches nearly 90% of that at 0.2 ItA. With more than 30% absorption, however, the discharge capacity levels off probably due to the fact that growth of cracks in the alloy peaks at 30% and levels off there.

As long as the amount of hydrogen absorbed is up to 30%, the more, the better; the necessary treating time becomes shorter. This could be due to the facts that the Ni-rich layer formed in the alloy, as a whole, ensures the amount of the magnetic material even when that Ni-rich layer is thin, and that the alloy is at a base potential and so Co and Ni are at potentials at which they are difficult to dissolve.

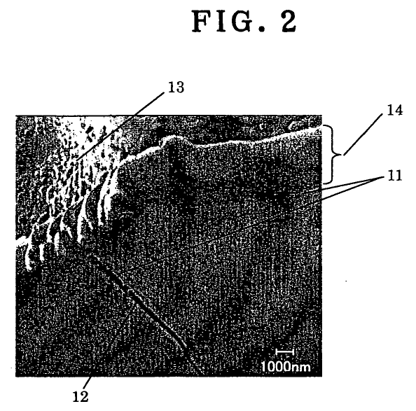

In both the inventive and comparative examples, the thickness of the nickel-rich layer was measured under a transmission electron microscope, and the fact that the interior of the inventive alloy was etched was confirmed under an electron microscope and with a focusing ion beam device. An enlarged sectional photograph taken of inventive alloy 1 with the focusing ion beam device is attached hereto as FIG. 2. As can be seen from FIG. 2, a nickel-rich layer 11 (looking like a whitish band) is formed not only on a surface 13 of the hydrogen storing alloy but also on the surface of cracks 12 (looking like a black band) running down from the surface. This photograph, taken of the sample at an angle of 45°, has a longitudinal magnification 1/\sqrt{2} times as high as a transverse one. A vapor deposited platinum layer 14 is provided as an aid to observation.

### Comparative Example 2

A hydrogen storing alloy was obtained as in inventive powder 1 with the exception that, of ions and hydroxides generated at the second step and composed mainly of rare earth components, the hydroxides were removed by filtration-under-pressure alone without ever carrying out any after-treatment. This alloy is called comparative powder 2, and the corresponding battery comparative 2. As a result of measuring the powder resistance of inventive alloy 1 and comparative alloy 2, the volume resistivity at a bulk density of 4.0 g/cm³ was 25 mΩ·cm and 300 mΩ·cm, respectively. The discharge capacity of comparative battery 2 was 8% after it was charged at 0.1 ItA for 12 hours, then let alone at 5° C. for 5 hours for adequate cooling, and finally discharged to 0.8 V at 10 ItA. A possible reason for this could be that a failure in full separation of the hydroxides of rare earths such as lanthanum causes some hydroxides to remain around the alloy powder, leading to conductivity drops and, hence, high-rate discharge capability drops.

### Comparative Example 3

An alloy obtained by holding the alloy in a vacuum and drying it without ever carrying out any desorption of hydrogen by hydrogen peroxide generated heat upon contact with air, probably by reason of oxidization. This alloy was used to prepare a battery according to the foregoing process, called comparative battery 3. Comparative battery 3 was found to have a capacity of barely 25 mAh at the fourth cycle in the activation process. A possible reason for this could be that although hydrogen desorption is carried out in a vacuum, there are some hydrogen residues, which are oxidized upon atmospheric air to generate heat that then causes the alloy to be oxidized to a nearly inactivation level.

Alloys were prepared as in inventive alloy 1 with the exception that, at the second step, the aqueous solution of NaOH was regulated to densities of 1.1, 1.2, 1.3, 1.4 and 1.5 g/cm³ at 20 and a mass saturation magnetization of 5 emu/g was obtained at 110° C. The treating times necessary for the obtained alloys and the content of magnetic nickel in the obtained alloys are set out in Table 2.

TABLE 2

| specific gravity | how much time was needed | |
|---|---|---|
| of NaOH aqueous | to obtain the target mass | magnetic nickel |
| solution | saturation magnetization (h) | content (mmol/g) |
| 1.1 | mass saturation magnetization | 0.42 |
| | of 2 emu/g was obtained in | |
| | 20 hours treatment | |
| 1.2 | mass saturation magnetization | 0.63 |
| | of 2 emu/g was obtained in | |
| | 20 hours treatment | |
| 1.3 | 8.0 | 1.05 |
| 1.4 | 2.5 | 1.05 |
| 1.5 | 1.7 | 1.05 |

The rate of increases in the value of mass saturation magnetization and the magnetic nickel content has the same meanings as the treating rate, and as can be appreciated from Table 2, the surface treating rate is extremely down at a specific gravity of less than 1.3. This teaches that the specific gravity of the NaOH aqueous solution is preferably equal to or greater than 1.3 and equal to or less than 1.5 at which NaOH crystals do never precipitate at normal temperature.

Alloys were prepared as in inventive alloy 1 with the exception that, at the second step, the aqueous solution of NaOH was set at 90° C., 100° C., 110° C. and 120° C., and the boiling point was selected in such a way as to obtain a mass saturation magnetization of 5 emu/g. The treating times necessary for the obtained alloys and the content of magnetic nickel in the obtained alloys are set out in Table 3.

TABLE 3

| temperature of the | how much time was needed | |
|---|---|---|
| NaOH aqueous | to obtain the target mass | magnetic nickel |
| solution (° C.) | saturation magnetization (h) | content (mmol/g) |
| 90 | mass saturation magnetization | 0.63 |
| | of 3 emu/g was obtained in | |
| | 10 hours treatment | |
| 100 | 4.0 | 1.05 |
| 110 | 1.7 | 1.05 |
| 120 | 1.6 | 1.05 |
| boiling point | 0.5 | 1.05 |

As can be noted from Table 3, the treating rate is extremely down at a treating temperature of less than 100° C. This teaches that the temperature of the NaOH aqueous solution used for treatment is preferably equal to or higher than 100° C., and the treatment at the boiling point is more preferable because of remarkable increases in the treating rate. Application of pressure and selection of a higher boiling point may make much faster treatment feasible, but render the system far costly.

### Examples 6, 7, 8, 9, 10

In Table 4, there are shown the necessary treating times for alloys obtained as in inventive alloy 1 with the exception that the mass saturation magnetization (emu/g in unit) was controlled by the treating time to 1.0, 2.5, 4.0, 5.0, 8.0, 9.0 and 10.0. Of these alloys, alloys of 1.0, 2.5, 4.0, 5.0, 8.0 and 9.0 in mass saturation magnetization (emu/g in unit) are called inventive alloys 6, 7, 8, 1, 9 and 10, and the corresponding batteries inventive batteries 6, 7, 8, 1, 9 and 10. Untreated alloys of 0.25 and 10.0 in mass saturation magnetization are referred to as comparative alloys 4 and 5, and the corresponding batteries as comparative batteries 4 and 5. The aforesaid method was used to measure these alloys for the thickness of the Ni-rich layer and the magnetic nickel content.

Each of those alloys was formed into a negative electrode according to the method for inventive battery 1, thereby obtaining a negative electrode-testing electrode of 32.5 mm×30 mm. One such negative electrode-testing electrode was sandwiched between two positive electrode plates, each prepared for activation inventive battery 1 and sized to 34 mm×34 mm, together with the aforesaid separators and a 10-mm thick acrylic resin plate, thereby obtaining an element. The aforesaid electrolyte was poured in a battery casing with the element encased in it to obtain an open type battery. A cycle involving a 16-hour charge at 25° C. and 0.1 ItA and a discharge to −0.6 V relative to a Hg/HgO reference electrode at 0.2 ItA was applied to the obtained battery five times to find the discharge capacity at the fifth cycle, i.e., the capacity of the negative electrode plate. The discharge capacity of each battery was found after it was charged at 0.1 ItA for 12 hours, then let alone at 5° C. for 5 hours for adequate cooling, and finally discharged to 0.8 V at 7 ItA and 10 ItA. Further, a cycle involving a charge to ΔV 5 mV at 25° C. and 2 ItA, a 10-minute break, a discharge to 1.0 V at 2 ItA and a 10-minute break was repeated to find the number of cycles at which a discharge capacity of 80% was reached. As in Table 1, the thicknesses of the Ni-rich layers shown in Table 4 are the measurements of the Ni-rich layers formed on the surfaces of the hydrogen storing alloy powder, and given by two significant figures in the median value of measurements at ten sites each. It is also noted that although the thicknesses of the Ni-rich layers along the cracks in the inventive alloy powder is not mentioned, they were found to be at most twice as large as those on the surfaces of the powder.

TABLE 4

| | | mass saturation | Ni-rich layer | magnetic | discharge capacity | discharge | dischrge | |
|---|---|---|---|---|---|---|---|---|
| | treating | magnetization | thickness | nickel content | of the negative | capacity at | capacity at | number |
| example | time (h) | (emu/g) | (nm) | (mmol/g) | electrode (mAh) | 7 ItA (%) | 10 ItA (%) | of cycles |
| comparative | 0.0 | 0.25 | 0 | 0.11 | 292 | 6 | 4 | 500 |
| example4 | | | | | | | | |
| example6 | 0.5 | 1.0 | 50 | 0.21 | 300 | 10 | 4 | 610 |
| example7 | 1.0 | 2.5 | 150 | 0.53 | 297 | 78 | 10 | 680 |
| example8 | 1.3 | 4.0 | 170 | 0.84 | 295 | 82 | 76 | 750 |
| example1 | 1.7 | 5.0 | 200 | 1.05 | 290 | 83 | 80 | 800 |
| example9 | 6.0 | 8.0 | 320 | 1.68 | 270 | 85 | 83 | 740 |
| example10 | 10.0 | 9.0 | 400 | 1.89 | 260 | 88 | 88 | 600 |
| comparative | 12.0 | 10.0 | 450 | 2.10 | 200 | 72 | 60 | 110 |
| example5 | | | | | | | | |

Inventive battery 6 having a treating time of 0.5 hour and a Ni-rich layer thickness of 50 nm is found to have a mass saturation magnetization of less than 2.5 emu/g and a magnetic nickel content of less than 0.5 mmol/g. Thus, although inventive battery 6 is a little more improved in high-rate discharge than comparative battery 4 as can be noted from a discharge capacity of 10% at 5° C. and 7 ItA, yet its cycle life performance is much more improved. A possible reason for this could be that although the alloy activity is not as high as high-efficient discharge is much more improved, there is an alloy surface corrosion accelerated by the treatment, which prevents growth of alloy corrosion in the battery.

Inventive battery 7 having a mass saturation magnetization of 2.5 emu/g and a magnetic nickel content of 0.53 mmol/g is much more improved in terms of high-rate discharge capability at 5° C. and 7 ItA, although a discharge capacity of barely about 10% is obtained at 5° C. and 10 ItA. At a mass saturation magnetization of 4.0 emu/g or greater and a Ni-rich layer thickness of 170 nm or greater, high-rate discharge capability is much more improved at both 10 ItA and 7 ItA. Consequently, it is understood that the mass saturation magnetization and the magnetic nickel content are preferably 2.5 emu/g or greater and 0.5 mmol/g or greater, and more preferably 4.0 emu/g or greater and 170 nm or greater, respectively. With comparative alloy 5 having a mass saturation magnetization of 10.0 emu/g exceeding 9.0 emu/g and a magnetic nickel content of 2.10 mmol/g exceeding 1.9 mmol/g and a treating time of 12 hours exceeding 10 hours, a Ni-rich layer thickness becomes 450 nm exceeding 400 nm, and the amount of hydrogen absorbed becomes extremely small, resulting in decreases in high-rate discharge capability and cycle life performance.

A possible reason for this could be that although the activation of the alloy has proceeded, there is too much destruction of the composition of the alloy to be capable of absorbing hydrogen, which in turn causes the capacity of the alloy to drop with the result that both high-rate discharge capacity and cycle life performance become worse.

As a result, it is understood that for improvements in both high-rate discharge capability and cycle life, it is effective to adjust the thickness of the Ni-rich layer formed on the surface of the alloy to 50 nm to 400 nm, and especially for improvements in high-rate discharge capability, it is preferable to have a Ni-rich layer thickness of 170 to 400 nm. Besides, the treating time is preferably 0.5 hour to 10 hours.

### Examples 11, 12, 13

Alloy powder obtained as in Example 1, with the exception that 5% of yttrium were added to the Mm (Misch-metal) composition of a hydrogen storing alloy, is referred to as inventive alloy 11; alloy powder obtained as in Example 1, with the exception that 5% of ytterbium was added to the Mm composition, as inventive alloy 12; and alloy powder obtained as in Example 1, with the exception that 5% of erbium was added to the Mm composition, as inventive alloy 13. Batteries prepared using three such alloys are referred to as inventive batteries 11, 12 and 13. The results are set out in Table 5.

TABLE 5

| | | discharge capacity of | dischrge | |
|---|---|---|---|---|
| | treating | the negative | capacity at | number |
| example | time (h) | electrode (mAh) | 10 ItA (%) | of cycles |
| example1 | 0 | 290 | 80 | 800 |
| example11 | 5 | 286 | 85 | 1030 |
| example12 | 10 | 286 | 81 | 900 |
| example13 | 20 | 285 | 82 | 920 |

When conventional preparation processes are applied to alloys having yttrium, ytterbium, and erbium added into their compositions, it is impossible to obtain batteries having improved high-rate discharge capability because of slow activation. With the application of the inventive preparation process, however, more than 80% of the discharge capacity at the fourth discharge in the step wherein operation involving a 12-hour charge at 0.1 ItA and a discharge down to 1 V at 0.2 ItA was repeated four times could be achieved in the aforesaid formation step with a 10 ItA high-rate discharge at 5° C. The corrosion resistance of the alloy is represented by the necessary treating time, indicating that, in Examples 11, 12 and 13, cycle life is much more improved by improvements in the corrosion resistance of the alloy. Especially in Example 11 with the addition of yttrium, cycle life performance of as high as 1,030 cycles was obtained.

When there was an alkalinity of pH 9 or higher at the fourth step of desorption of hydrogen out of the alloy, no desorption of hydrogen took place even at a temperature elevated to 80° C., and at a temperature of lower than 80° C., no desorption of hydrogen occurred even at pH 9 or less, either. At the fifth step of partial oxidization of the alloy by air, no sufficient oxidization took place at 60° C. or lower, or else a few hours were taken to dry the alloy. At a temperature of 90° C. or higher, the partial oxidization proceeded too much, leading to an alloy activity drop and giving rise to a phenomenon incapable of high-rate discharge.

When, in Example 1, the positive electrode active material particles were not oxidized (Ni and Co contained in the positive electrode active material particles had an average oxidation number of 2.0), the number of cycles became smaller than in Example 1 shown in Table 4. Although no detailed reasons are given, it was found that as Ni and Co had an average oxidation number of 2.04 to 2.4, it was effective for reductions in the amount of formation discharge reserve and, hence, improvements in discharge capacity and cycle performance.

It is appreciated that the invention is in no sense limited to the starting materials for the active materials, preparation process, positive electrode, negative electrode, electrolyte, separator and battery configuration described in the examples.

### POSSIBLE APPLICATIONS TO THE INDUSTRY

The battery of the invention is typically usable as power sources for electric-powered equipments requiring high-current discharge, inclusive of electric cars and electric-powered tools.

1. A sealed type nickel-metal hydride battery, comprising a positive electrode comprising an active material composed mainly of nickel hydroxide, a negative electrode comprising a hydrogen storing alloy powder composed mainly of rare earth elements, nickel and transition metal elements that absorb and desorb hydrogen, and an electrolyte composed mainly of an aqueous solution of an alkaline metal hydroxide, wherein:
a layer that contains more nickel than does a matrix component and has a thickness of 50 nm to 400 nm inclusive is located on a surface of said hydrogen storing alloy powder, and layers that contain more nickel than does a matrix component are located on a surface of cracks that open at the surface of said hydrogen storing alloy powder.

2. The sealed type nickel-metal hydride battery according to claim 1, wherein said hydrogen storing alloy powder has a mass saturation magnetization of 2.5 to 9 emu/g.

3. The sealed type nickel-metal hydride battery according to claim 1, wherein said hydrogen storing alloy powder contains magnetic nickel in an amount of 0.5 to 1.9 mmol per gram.

4. The sealed type nickel-metal hydride battery according to claim 2, wherein said hydrogen storing alloy powder contains magnetic nickel in an amount of 0.5 to 1.9 mmol per one gram.

5. The sealed type nickel-metal hydride battery according to any one of claims 1 to 4, wherein the cracks in said hydrogen storing alloy powder is formed by absorption of hydrogen in the alloy powder, and the hydrogen storing alloy powder with the cracks formed therein is treated with an alkaline aqueous solution, whereby the layer that contains more nickel than does the matrix component is formed.

6. The sealed type nickel-metal hydride battery according to any one of claims 1 to 4, wherein said hydrogen storing alloy further contains one or two or more metals selected from the group consisting of erbium, yttrium, and ytterbium.

7. The sealed type nickel-metal hydride battery according to claim 5, wherein said hydrogen storing alloy further contains one or two or more metals selected from the group consisting of erbium, yttrium, and ytterbium.

8. A process for preparing a sealed type nickel-metal hydride battery as recited in any one of claims 1 to 4, comprising:
a first step of absorbing hydrogen in said hydrogen storing alloy powder composed mainly of rare earth elements, nickel and transition metal elements, thereby to form cracks therein,
a second step of treating the surface of the alloy powder and portions of the cracks that open at the surface of the alloy powder with an alkaline aqueous solution,
a third step of removing ions and hydroxides generated by treatment at the second step and composed mainly of the rare earth elements,
a fourth step of desorbing hydrogen out of the alloy powder, and
a fifth step of partially oxidizing the alloy powder by air.

9. A process for preparing a sealed type nickel-metal hydride battery as recited in claim 6, comprising:
a first step of absorbing hydrogen in said hydrogen storing alloy powder composed mainly of rare earth elements, nickel and transition metal elements, thereby to form cracks therein,
a second step of treating the surface of the alloy powder and portions of the cracks that open at the surface of the alloy powder with an alkaline aqueous solution,
a third step of removing ions and hydroxides generated by treatment at the second step and composed mainly of the rare earth elements,
a fourth step of desorbing hydrogen out of the alloy powder, and
a fifth step of partially oxidizing the alloy powder by air.

10. The sealed type nickel-metal hydride battery preparation process according to claim 8, wherein said cracks are formed by absorbing hydrogen in the said hydrogen storing alloy powder in an amount of 5% or more of an hydrogen absorption amount of the alloy powder.

11. The sealed type nickel-metal hydride battery preparation process according to claim 9, wherein said cracks are formed by absorbing hydrogen in the said hydrogen storing alloy powder in an amount of 5% or more of an hydrogen absorption amount of the alloy powder.

12. The sealed type nickel-metal hydride battery preparation process according to claim 8, wherein said alkaline aqueous solution is an aqueous solution of sodium hydroxide having a specific gravity of 1.3 to 1.5 at 20° C., and the treatment at the second step is carried out at a temperature of 100° C. to a boiling point of said aqueous solution for 30 minutes to 10 hours.

13. The sealed type nickel-metal hydride battery preparation process according claim 9, wherein said alkaline aqueous solution is an aqueous solution of sodium hydroxide having a specific gravity of 1.3 to 1.5 at 20° C., and the treatment at the second step is carried out at a temperature of 100° C. to a boiling point of said aqueous solution for 30 minutes to 10 hours.

14. The sealed type nickel-metal hydride battery preparation process according to claim 8, wherein at the step of removing the ions and hydroxides generated by the treatment at the second step and composed mainly of the rare earth elements, the hydroxide is dissolved and ionized using an acid, whereby the ions composed mainly of the rare earth elements are separated from the hydrogen storing alloy powder by means of filtration.

15. The sealed type nickel-metal hydride battery preparation process according to claim 9, wherein at the step of removing the ions and hydroxides generated by the treatment at the second step and composed mainly of the rare earth elements, the hydroxides are dissolved and ionized using an acid, whereby the ions composed mainly of the rare earth elements are separated from the hydrogen storing alloy powder by means of filtration.

16. The sealed type nickel-metal hydride battery preparation process according to claim 8, wherein at the step of desorbing hydrogen out of said alloy powder, hydrogen is desorbed out of the alloy powder by treating with warm water having a temperature of 80° C. or higher and a pH of 9 or less, and hydrogen peroxide solution is added as an oxidizing agent to the alloy powder at 45° C. or lower.

17. The sealed type nickel-metal hydride battery preparation process according claim 9, wherein at the step of desorbing hydrogen out of said alloy powder, hydrogen is desorbed out of the alloy powder by treating with warm water having a temperature of 80° C. or higher and a pH of 9 or less, and hydrogen peroxide solution is added as an oxidizing agent to the alloy powder at 45° C. or lower.

18. The sealed type nickel-metal hydride battery preparation process according to claim 8, wherein at the step of partially oxidizing said alloy powder by air, the alloy powder is partially oxidized by air having a temperature of 60 to 90° C.

19. The sealed type nickel-metal hydride battery preparation process according to claim 9, wherein at the step of partially oxidizing said alloy powder by air, the alloy powder is partially oxidized by air having a temperature of 60 to 90° C.

20. A process of preparing a sealed type nickel-metal hydride battery as recited in any one of claims 1 to 4, wherein the battery is prepared using a positive electrode in which the transition metal elements contained in said active material composed mainly of nickel hydroxide has an average oxidation number of 2.03 to 2.4.

21. A process of preparing a sealed type nickel-metal hydride battery as recited in claim 6, wherein the battery is prepared using a positive electrode in which the transition metal elements contained in said active material composed mainly of nickel hydroxide has an average oxidation number of 2.03 to 2.4.

22. The sealed type nickel-metal hydride battery preparation process according to claim 20, wherein said active material composed mainly of nickel hydroxide is chemically oxidized with an oxidizing agent or electro-chemically oxidized by electrolysis.

23. The sealed type nickel-metal hydride battery preparation process according to claim 21, wherein said active material composed mainly of nickel hydroxide is chemically oxidized with an oxidizing agent or electro-chemically oxidized by electrolysis.
